(19) United States
(12) Patent Application Publication
(10) Pub. No.: US 2021/0232987 A1
(43) Pub. Date: Jul. 29, 2021

(54) LOGICAL-TO-PHYSICAL PRODUCTION SYSTEM ALIGNMENT AND DEVELOPMENT

(71) Applicant: THE BOEING COMPANY, Chicago, IL (US)

(72) Inventors: Hung L. Nguyen, Seattle, WA (US); Alejandra M. Rondon, Snohomish, WA (US); James M. Milstead, Athens, AL (US)

(21) Appl. No.: 16/750,523

(22) Filed: Jan. 23, 2020

(51) Int. Cl. G06Q 10/06; G06Q 10/08; G06Q 50/04; G05B 19/4097

(52) U.S. Cl. CPC G06Q 10/067; G06Q 10/0875; G05B 2219/35134; G05B 19/4097; G06Q 50/04

(57) ABSTRACT

A method of developing a production system that is aligned with the logical and physical requirements of the production system. The method includes building a logical control node as a structured data object containing a hierarchical list of design requirements associated with a portion of a production system. The logical control node is combined with other logical control nodes associated with other portions of the production system based on relationships between the respective requirements stored in the logical control nodes. The logical network is then converted into a physical model of the production system by converting the logical control nodes into their related physical nodes and confirming the arrangement of the physical nodes conforms to the relationships established in the logical network and any other relevant requirements stored in the logical control nodes.

### TECHNOLOGICAL FIELD

The present disclosure relates generally to the development, design, and implementation of production systems. In particular, example implementations of the present disclosure involve the use of logical control nodes to align logical and physical design requirements of a complex production system in a dynamic development environment.

### BACKGROUND

The design, development, and implementation of effective production systems has become increasingly important in the efficient manufacturing of products. Ever since the introduction of the modern product assembly line, production systems, such as those used in connection with the construction of vehicles, consumer electronics, and home appliances, for example, have played a central role in how products are made and how people perform their work manufacturing those products. The need for production systems that are able to properly support products and the people, tools, machines, and materials necessary to make those products is particularly prevalent in situations involving large products or subassemblies, complex structures, technical precision, close tolerances, and non-trivial timing requirements. In some such situations, a range of technical challenges can act individually and collectively to limit the ability to make a given product or subassembly to specifications in an efficient manner. One recurring issue that can manifest in continuation production system development is the determination at or after initial deployment that the production system fails to meet technical or business requirements, or otherwise fails to exhibit the expected technical performance. Issues that are not discovered until after a production system has been built and deployed can be costly to fix, both in terms of time and financial resources needed to rework the actual production system and in terms of the lost production capacity associated with an out-of-spec production system.

One underlying technical challenge that can lead to the development and deployment of a production system that fails to meet its specifications and intended performance involves the difficulty in identifying how design changes that impact a product, subassembly, or a portion of a production system impact other portions of the production system. In situations where authoritative design information is neither centralized nor readily shared, the production system development process is often vulnerable to design and specification changes that are not reflected in the initially deployed production system.

Therefore, it would be desirable to have a system and method that takes into account at least some of the issues discussed above, as well as other possible issues.

### BRIEF SUMMARY

Example implementations of the present disclosure are directed to development, design, and implementation of production systems. In particular, example implementations of the present disclosure involve the use of logical control nodes and a logical network made up of interconnected logical control nodes to efficiently and automatically align logical and physical design requirements of a complex production system in a dynamic development environment, resulting in a physical model of a production system that reflects and meets the relevant design requirements.

Example implementations may overcome the technical challenges associated with conventional approaches to the development, design, and deployment of production systems by building a logical control node configured as a structured data object containing a hierarchical list of design requirements associated with the first portion of a production system. The logical control node can then be incorporated into a logical network with a plurality of other logical control nodes based on relationships between nodes, and converted into a physical model of the production system by converting each logical control node into a physical node and arranging the nodes based on their respective relationships. Since the logical control nodes (and their physical counterparts) are linked based on relationships between the nodes, such as design requirements that impact multiple nodes, changes to specifications or other design requirements in one node can be rapidly and authoritatively shared among related nodes, and stakeholders associated with such nodes can be notified of the changes at issue.

The present disclosure thus includes, without limitation, the following example implementations.

Some example implementations provide a method for developing a production system, the method comprising building a first logical control node associated with a first portion of a production system, the first logical control node configured as a structured data object containing a first hierarchical list of design requirements including at least one of a tooling requirement, equipment requirement, operational requirement, facility requirement, materials requirement, or assembly requirement associated with the first portion of the production system; incorporating the first logical control node into a logical network comprising a plurality of logical control nodes associated with a plurality of other portions of the production system, incorporating the first logical control node including: identifying a second logical control node from the plurality of logical control nodes, the second logical control node containing a second hierarchical list of design requirements of a second portion of the production system; determining a relationship between a first design requirement stored in the first logical control node and a second design requirement stored in the second logical control node; and defining a link between the first logical control node and the second logical control node based on the relationship; and converting the logical network into a physical model of the production system comprising a rendering of the production system, converting the logical network including: converting the first logical control node into a first physical node defining a spatial arrangement of design elements within the first portion of the production system; converting the second logical control node into a second physical node defining a spatial arrangement of design elements within the second portion of the production system; and arranging the first physical node and the second physical node in the physical model based on the relationship between the first design requirement stored in the first logical control node and the second design requirement stored in the second logical control node.

In some example implementations of the method of any preceding example implementation, or any combination of any preceding example implementations, defining a link between the first logical control node and the second logical control node comprises: determining a precedential order between the first logical control node and the second logical control node; and incorporating an indication of the precedential order into the link between the first logical control node and the second logical control node.

In some example implementations of the method of any preceding example implementation, or any combination of any preceding example implementations, the method further includes receiving an update to the first design element stored in the first logical control node; determining a relationship between the updated design requirement and the second design requirement stored in the second logical control node by identifying the link between the first logical control node and the second logical control node; and providing an indication of the updated design requirement to the second logical control node.

In some example implementations of the method of any preceding example implementation, or any combination of any preceding example implementations, the method further includes generating a user-readable notification of the update to the first design requirement and adding the user-readable notification to the first logical control node and the second logical control node.

In some example implementations of the method of any preceding example implementation, or any combination of any preceding example implementations, the hierarchical list of design requirements comprises a design requirement received from a first data repository and a design requirement received from a second data repository, wherein the first data repository is not configured to communicate with the second data repository.

In some example implementations of the method of any preceding example implementation, or any combination of any preceding example implementations, converting the logical network into a physical model of the production system further comprises comparing the physical model of the production system to the hierarchical list of design requirements associated with the first portion of the production system and the hierarchical list of design requirements associated with the second portion of the production system.

In some example implementations of the method of any preceding example implementation, or any combination of any preceding example implementations, the physical model of the production system comprises a three-dimensional rendering of a spatial arrangement of design elements within the production system.

Some example implementations provide an apparatus for developing a production system, the apparatus comprising processing circuitry and a memory storing executable instructions that, in response to execution by the processor, cause the apparatus to at least perform the method of any preceding example implementation, or any combination of any preceding example implementations.

Some example implementations provide a computer-readable storage medium for developing a production system, the computer-readable storage medium being non-transitory and having computer-readable program code portions stored therein that in response to execution by a processor, cause an apparatus to at least: perform the method of any preceding example implementation, or any combination of any preceding example implementations.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURES

Having thus described example implementations of the disclosure in general terms, reference will now be made to the accompanying figures, which are not necessarily drawn to scale, and wherein:

FIG. 1 illustrates a block diagram of a logical control node and a corresponding physical node, according to some example implementations of the present disclosure;

FIG. 2 illustrates a block diagram of an example logical network according to some example implementations of the present disclosure;

FIG. 3 illustrates a method by which a production system may be developed, according to some example implementations of the present disclosure; and

FIG. 4 illustrates an apparatus according to some example implementations of the present disclosure.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless specified otherwise or clear from context, references to first, second or the like should not be construed to imply a particular order. A feature may be described as being above another feature (unless specified otherwise or clear from context) may instead be below, and vice versa; and similarly, features described as being to the left of another feature else may instead be to the right, and vice versa. As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Like reference numerals refer to like elements throughout.

Example implementations of the present disclosure relate generally to the development, arrangement, and deployment of production systems. As used herein, the term “production system” refers to a system used to form, assemble, or otherwise produce a manufactured item and the facilities, tooling, equipment, material flow, workflow, and processes used to do so. In many modern contexts, a production system is made up of multiple stations or other portions at which one or more specific, predefined tasks are performed in support of the manufacture of a given product. In some such production systems, an assembly line or other workflow defines and allows the movement of a product from one position to a subsequent position for additional work or other processing. Some of the examples described herein arise in the context of the production of vehicles (such as aircraft, for example), including but not limited to the various components and subassemblies incorporated into such vehicles. As such, some of the examples herein use terms and concepts that are used in that context. However, it will be appreciated that example implementations of the present disclosure are not confined to such as context, and may instead involve production systems in other situations or contexts.

One recurring issue encountered in the development of production systems is that of a developed and deployed production system failing to meet business requirements, technical requirements, or technical performance expectations. The costs in time and resources necessary to rework and improve a production system after its deployment can be significant. For example, in production systems where the facilities, tooling, equipment, material flow, workflow, and other processes must be reworked and redesigned to meet various requirements, the costs can include significant amounts of money, time, and other resources. Many of these costs are compounded in the form of lost production and lost opportunity costs associated with the inability to effectively produce items to schedule or specification, particularly where modifications to the production system disrupt manufacturing operations.

Conventional approaches to production system design tend to contribute to the development and deployment of productions systems that fail to meet their various requirements. For example, the relationship between the requirements associated with a given portion of a production system are often only loosely correlated to a related, physical definition, which can result in a failure to account for issues that arise when the production system is implemented in actual, three-dimensional space. Moreover, since physical components of a production system are typically integrated at the later stages of the deployment of a production system (and sometimes after construction has progressed significantly), potential incompatibilities or other issues associated with the positioning of equipment, tooling, and other aspects of a portion of a production system may not be detected in a manner that allows for efficient remediation.

Other aspects of conventional production system design and development raise additional technical issues. The typical approaches to production system design and development are document-centric and document-intensive. Particularly in complex production systems that involve one or more of specialized equipment, specialized materials, exacting product specifications, particularized skills, or other complicating factors, for example, the documentation involved with the various requirements, specifications, and other information associated with each aspect of the production system and its intended operations can be extensive, and may further involve information from multiple, unrelated sources. The conventional, manual approach to managing such documentation gives rise to multiple inefficiencies and technical challenges. For example, multiple interactions among various individuals may be necessary to acquire and compile all of the necessary documentation. In situations where various individuals and other entities are not geographically co-located, such interactions can be impeded.

Additional efforts are often necessary to ensure that the acquired documentation is correct and current. In a production system that may involve thousands of features to be synchronized and harmonized between the products to be made, production system tooling and equipment specifications, facilities requirements, operator requirements, and logistic and supply chain requirements, for example, it is exceptionally difficult for one or more individuals to effectively and accurately maintain and use the documentation. Moreover, the typical process is often slow and incomplete in its response to design changes, both with respect to changes in the design of the product to be manufactured and in the requirements or other aspects of the production system itself. For example, where a change in the design of a subassembly may have a more readily ascertainable impact on the configuration of tooling or equipment used to make that subassembly, conventional approaches often fail to detect how changes in one portion of a production system impact other portions of the production system and the movement of materials through that production system.

Example implementations of the present disclosure address these and other technical challenges by using a one or more logical control nodes in a model-based approach to develop production systems in a manner that allows for requirements (and changes to requirements) to be effectively represented, shared, and stored throughout the design and development of a production system. In example implementations of the present disclosure, a logical control node is a structured data object that can be used to identify, store, align, and communicate the various requirements and other elements of a production system. Since all of the requirements, documentation, and other relevant information associated with a logical control node can be stored or associated with the logical control node, each logical control node can be used to establish a centralized location at which information governing a particular portion of a production system can be found. Moreover, by relating each logical control node to an analogous physical node (which contains a physical model or representation of the relevant physical production system elements for a portion of the production system), close alignment can be maintained between the requirements stored or otherwise associated with the logical control node and the physical result of those requirements, such that changes in requirements for a given node can be accurately reflected in a physical node and physical changes in the design of a given portion of a production system can be documented.

By arranging multiple logical control nodes into a logical network based on relationships between aspects of the relevant logical control nodes, the relationships and related requirements associated with connected logical control nodes can be used to align the various requirements associated with each portion of the production system and the production system as a whole. Moreover, since each logical control node can be configured as a centralized repository of information governing the logical control node and its related physical node, changes that are made at one logical control node can be readily conveyed through the network, such that the impact of the changes made at a given logical control node can be traced, communicated, and addressed throughout the production system. Once the logical control nodes are arranged in a network that reflects the requirements imposed on each logical control node and the relationships between the various logical control nodes, the logical network can be converted into a physical model of the production system by converting the logical control nodes into their related physical nodes and adjusting the arrangement of the physical nodes, to the extent needed.

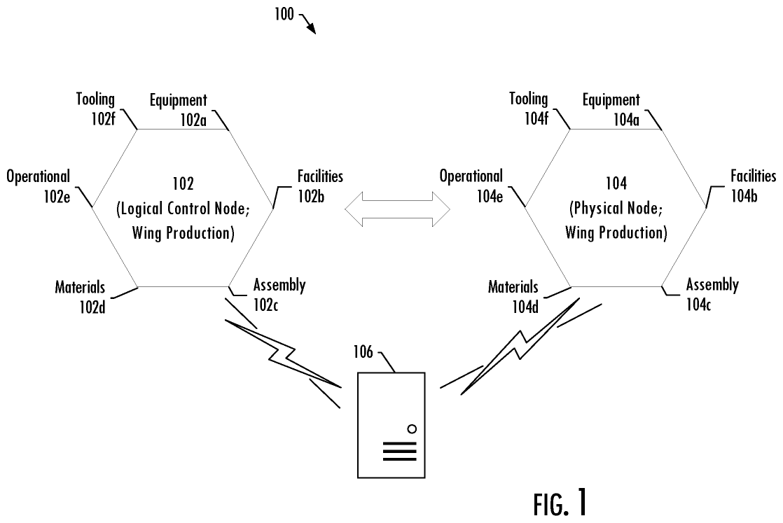

FIG. 1 illustrates a block diagram 100 of an example logical control node 102 and its related physical node 104. In example implementations of the present disclosure, a logical control node is a structured data object that contains a list of design requirements associated with a portion of a production system. In the example depicted in FIG. 1, example logical control node 102 represents the portion a production system for an airplane that involves the production of a wing. Consequently, several design requirements that govern that portion of the production system are stored in or otherwise contained in the example logical control node 102. For example, as depicted at block 102a, the example logical control node 102 includes an equipment requirement, which may include, for example, an identification of any pieces of equipment that must be included in the wing production portion of the production system, physical dimensions or other spatial requirements associated with that equipment, power requirements, use instructions, safety bulletins, product manuals, any other information associated with the equipment, and the like.

As shown in FIG. 1, example logical control node 102 includes multiple additional requirements, depicted as a facilities requirement 102b, an assembly requirement 102c, a materials requirement 102d, an operator or operational requirement 102e, and a tooling requirement 102f. In some example implementations, the facilities requirement 102b includes requirements and other information pertaining to the facility in which the portion of the production system reside, such as the dimensions of the allotted or available space, the availability and proximity of electrical power, fuels, liquids, or other utilities, the location of relevant structural members, and the like.

In some example implementations, the assembly requirement 102c includes the requirement or requirements for the product, subassembly, or other item that is produced, modified, or otherwise processed at the portion of the production system. For example, in the context of the wing production portion depicted in FIG. 1, the assembly requirement 102c may identify the components, fasteners, other parts, schematics, mechanical diagrams, tolerances, clearances, instructions, and the like.

In some example implementations, the materials requirement 102d includes requirements and other information pertaining to raw materials used, stored, or otherwise associated with the portion of the production system. For example, in the context of the wing production portion depicted in FIG. 1, the materials requirement 102d may include an identification of particular metals that are shaped or formed in the portion of the production system, dimensions associated with the raw materials, safety and handling information, storage requirements, and the like.

In some example implementations, the operational requirement 102e includes requirements and other information pertaining to the operation and use of the equipment, materials, and other aspects of the production system. In some example implementations, operational requirement 102e includes information pertaining to the required skills of any personnel who would work in the portion of the production system, spatial requirements associated with such personnel (such as the location and layout of workstations, for example), safety considerations, the time necessary to complete their assigned tasks, any automation available at the portion of the production system, and the like.

In some example implementations, the tooling requirement 102f includes requirements and other information pertaining to any tools or tooling required at the relevant portion of the production system. For example, in the context of the wing production portion depicted in FIG. 1, tooling requirement 102f may identify any specialized tools (such as torque wrenches, specialized screw drivers, riveters, hammers, planes, shaping tools, powered tools, heated tools, or the like, for example) or components thereof (such as consumable and/or replaceable portions of a tool, for example) that are to be used in the portion of the production system.

In some example implementations, the requirements contained in a logical control node are stored in a hierarchical list. In some example implementations, the hierarchy used to order the list of requirements may be derived from an operational precedence or logistic flow. For example, the various requirements associated with a logical control node, such as requirements 102a-102f depicted in connection with example logical control node 102, may be arranged in a hierarchical order that generally reflects the workflow associated with the portion of the production system. In the context of the wing production portion contemplated in FIG. 1, the hierarchical order may prioritize certain aspects of the equipment requirement (such as the presence of a particular piece of equipment needed to perform a critical task, for example), or a facilities requirement (such spatial requirements needed to move a wing from one position to another during production, for example) over other requirements. The hierarchical order may also reflect a relationship between the given portion of a production system and other portions of the production system. For example, where the output of one portion of a production system is a material or subassembly that is further processed or otherwise used in another portion of the production system, requirements that are necessary to the orderly flow of materials and products through the production system may be prioritized over less-essential requirements. However, it will be appreciated that the hierarchy reflected in a given logical control node and the list of requirements contained therein may depend on any of a number of factors, situations, and contexts, including but not limited to those particular to a given production system.

As discussed herein, some example implementations of the present disclosure address and overcome technical challenges associated with conventional approaches to production system design by establishing and maintaining a relationship between a logical control node (such as example logical control node 102, for example), and a corresponding physical node (such as example physical node 104, for example). A physical node, such example physical node 104, contains data defining a physical model or representation of the relevant physical production system elements for a portion of the production system. As shown in FIG. 1, example logical control node 102 and example physical node 104 are associated with each other, such that example physical node 104 reflects the physical aspects (such as the spatial, dimensional, and positional aspects, for example) of the various requirements contained in example logical control node 102. In the example shown in FIG. 1, the example physical node 104 includes an equipment requirement 104a, a facilities requirement 104b, an assembly requirement 104c, a materials requirement 104d, an operational requirement 104e, and a tooling requirement 104f, each of which reflect the physical aspects of their respective corresponding requirements 102a-102f.

In the context of the wing production portion contemplated in FIG. 1, the physical equipment requirement 104a may store data defining a physical model of a piece of equipment, and where it may be positioned within a portion of the production system, for example. In the same context, the physical facilities requirement 104b may store data defining the layout of the portion of the production system and the location of any structural columns or beams, for example. Similarly, the physical assembly requirement 104c may store data defining the size, shape, and movement of a workpiece as it moves through the portion of the production system, for example. The physical materials requirement 104d may store data defining the size and shape of raw materials and containers they may be stored in, for example. The physical materials requirement 104d may also store data defining distances or spaces associated with materials safety protocols, such as a minimum safe distance that should be maintained between two chemicals, or a material and a heat source, for example. The physical operational requirement 104e may store data defining the space a worker or robot needs to safely move and perform their assigned task, or clearances necessary to ensure that people, products, equipment, or other items are not injured or damaged during the operation of the production system. The physical tooling requirement 104f may store data defining any spatial or other physical requirements associated with any tools or tooling used in the portion of the production system.

In some example implementations of the present disclosure, the relationship between a logical control node (such as example logical control node 102) and its related physical node (such as example physical node 104) allow for changes to a requirement associated with the logical control node to be reflected in its correlating physical node, and for changes made to a physical node to be stored or otherwise reflected in the corresponding logical control node. As such, the logical control node can act as a reliable and accurate source of information regarding the requirements associated with a given portion of a production system and any changes in a physical representation of that portion of the production system that may not be otherwise documented or may potentially conflict with the underlying requirements.

It will be appreciated that, since a logical control node and a physical node can be configured as structured data objects, a logical control node and a physical node can be stored, accessed, processed, modified, and otherwise operated on by one or more computing devices, including but not limited to the computing device 106 shown in FIG. 1. In FIG. 1, the computing device 106 is configured to store one or more logical control nodes and corresponding physical nodes and information associated with such logical control nodes and physical nodes. It will be appreciated that, in some example implementations, the computing device 106 may interface with one or more networks to allow one or more users to view, add, edit, receive and otherwise interact with the logical control nodes, physical control nodes, related design requirements or any data set associated with example implementations of the present disclosure.

It will be appreciated that while the example depicted in FIG. 1 contemplates a portion of a production system where a wing of an aircraft is produced, a logical control node can be built or can otherwise exist at any level of decomposition of a production system. As such, it will be appreciated that the size, scope, and structure of a logical control node need not be confined to that which may be appropriate for a portion of a production system involved with items of only a similar level of size or complexity.

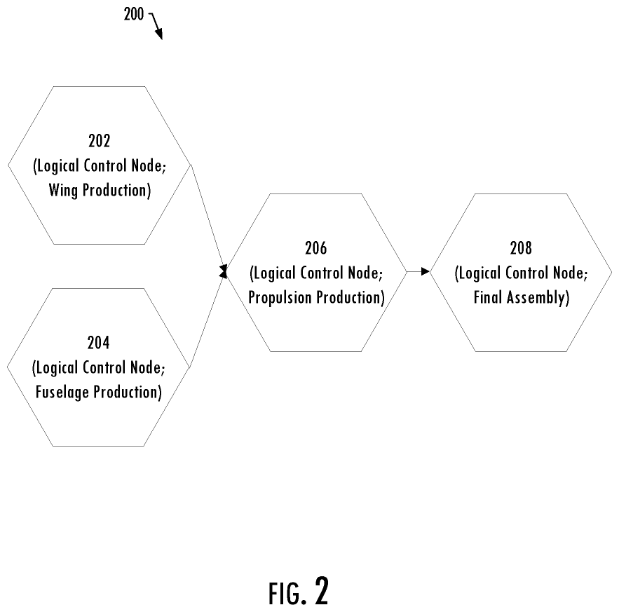

FIG. 2 illustrates a block diagram of an example logical network according to some example implementations of the present disclosure. To facilitate the development of a complex production system, some example implementations of the present disclosure contemplate combining multiple logical control nodes into a logical network. As shown in FIG. 2 a logical network 200 is formed through the connection of four logical control nodes 202, 204, 206, and 208, each of which are associated with a different portion of a production system. As with FIG. 1, the example logical network in FIG. 2 arises in the context of a production system configured to construct an aircraft. As such, FIG. 2 includes node 202, which is associated with a portion of a production system at which a wing is constructed, node 204, which is associated with a portion of a production system at which a fuselage is constructed, node 206, which is associated with a portion of a production system where propulsion systems are constructed and mounted to the aircraft, and node 208, which is associated with a portion of a production system where final assembly of the aircraft is performed.

In keeping with some example implementations of the present disclosure, the logical control nodes 202, 204, 206, and 208 are connected based on relationships between design requirements associated with each logical control node 202-208. In the example depicted in FIG. 2, the relationships used to establish connections between the logical nodes 202-208 are primarily based on a workflow associated with the logical control nodes, such that the wing and fuselage produced at the portions of the production system associated with nodes 202 and 204, respectively, are components used in the portion of the production system associated with node 206 (since the particular aircraft in the example contemplated in FIG. 2 involves the wing(s) and fuselage both being necessary for the proper production and fitting of the propulsion system(s)). As such, both node 202 and 204 are shown as being independently connected to node 206. Similarly, since the combined wing-fuselage-propulsion system combination is passed to final assembly, node 206 is shown as being connected to node 208.

It will be appreciated that while linking logical control nodes based on the movement of materials, subassemblies, or other products from one portion of a production system to a subsequent portion of the production system will often be sufficient to establish an advantageous logical network, any relationship between logical control nodes, including but not limited to any relationship based on the various requirements stored in a logical control node, may be used to establish a link between one or more nodes and thereby form a logical network. For example, relationships may be established between nodes based on aspects of the equipment requirements, facilities requirements, assembly requirements, materials requirements, operational requirements, and/or tooling requirements associated with any given nodes.

It will also be appreciated that linking logical control nodes to establish a logical network can, in some example implementations, facilitate the identification of requirements changes that impact the production system beyond the limits of the portion of the production system at which the change is made. For example, with reference to FIG. 2, if a change to a requirement is made with respect to the fuselage, that change can be recorded and stored at node 204, and the network can be traversed to pass information about that change to node 206 and, in some example implementations, to node 208, to determine if the change with respect to the fuselage impacts the requirements associated with any other related logical control node.

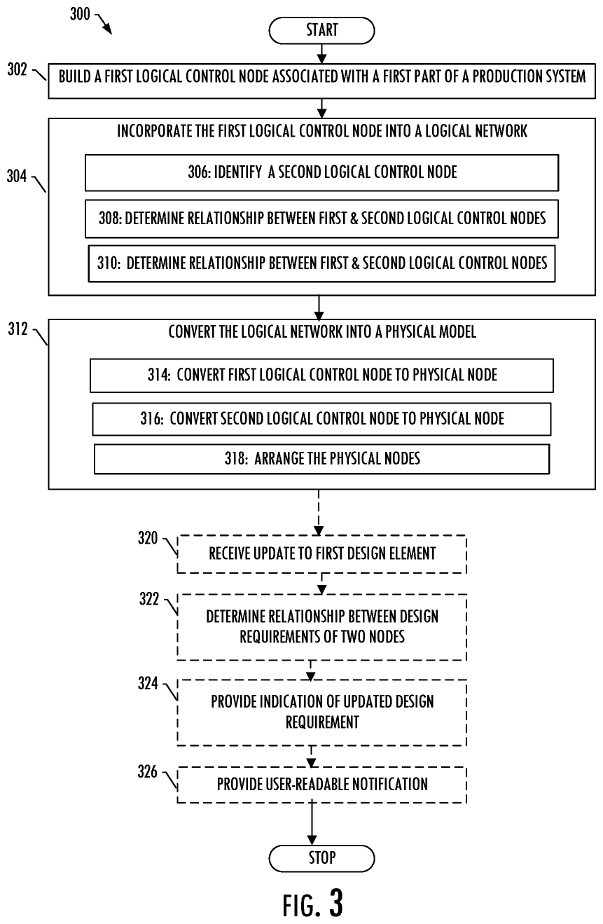

FIG. 3 is a flowchart illustrating a method 300 by which a production system may be developed, according to some example implementations of the present disclosure. As shown at block 302, the method 300 includes building a first logical control node associated with a first portion of a production system. Some example implementations of block 302 include building a first logical control node associated with a first portion of a production system, the first logical control node configured as a structured data object containing a first hierarchical list of design requirements including at least one of a tooling requirement, equipment requirement, operational requirement, facility requirement, materials requirement, or assembly requirement associated with the first portion of the production system. It will be appreciated that any aspect of the logical control node 102 discussed in connection with FIG. 1 or otherwise disclosed or contemplated herein may be used in example implementations of block 302. In some example implementations of block 302, the hierarchical list of design requirements comprises a design requirement received from a first data repository and a design requirement received from a second data repository, wherein the first data repository is not configured to communicate with the second data repository. It will be appreciated that, especially in production systems involving complex products or complex operations, the design requirements associated with a given logical control node may originate for multiple different sources that are not configured to communicate with each other. For example, one design requirement might incorporate information from an equipment supplier, while another design requirement might incorporate information from an unrelated vendor. As such, the first design requirement may originate from a data storage system, library, or other repository of information that is not configured to communicate with the data storage system, library, or other repository of information from which the second design requirement is received.

As shown at block 304, the method 300 also includes incorporating the first logical control node into a logical network comprising a plurality of logical control nodes. Some example implementations of block 304 include incorporating the first logical control node into a logical network comprising a plurality of logical control nodes associated with a plurality of other portions of the production system. It will be appreciated that any approach to incorporating a logical control node into a logical network discussed in connection with FIG. 2 or otherwise disclosed or contemplated herein may be used in connection with example implementations of block 304.

FIG. 3, in blocks 306, 308, and 310, depicts one approach to implementing block 304. As shown in FIG. 3, block 306 includes identify a second logical control node. Some example implementations of block 306 include identifying a second logical control node from the plurality of logical control nodes, the second logical control node containing a second hierarchical list of design requirements of a second portion of the production system. It will be appreciated that the second logical control node may take the form and structure of any of the logical control nodes discussed, depicted, or otherwise disclosed herein.

As shown at block 308, implementations of block 304 may further include determining a relationship between the first control node and the second control node. Some example implementations of block 308 include determining a relationship between a first design requirement stored in the first logical control node and a second design requirement stored in the second logical control node. In some example implementations of block 308, the relationship between the design requirements may be a precedential relationship, such as one that defines a direction of workflow, for example, where the output of one portion of a production system can be considered an input of another portion of the production system. However, it will be appreciated that any relationship between design requirements may be used in connection with example implementations of block 308.

As shown at block 310, implementations of block 304 may further include defining a link between the first logical control node and the second logical control node. Some example implementations of block 310 include defining a link between the first logical control node and the second logical control node based on the relationship. It will be appreciated that any approach to defining a link between two logical control nodes may be used in example implementations of block 310. In some example implementations, information regarding the link may be stored in one or both of the related logical control nodes. For example, in some example implementations of block 310, defining a link between the first logical control node and the second logical control node comprises determining a precedential order between the first logical control node and the second logical control node; and incorporating an indication of the precedential order into the link between the first logical control node and the second logical control node. In some example implementations, information regarding links between nodes may be stored in a registry of other data repository that can be referenced when traversing the logical network.

As shown in block 312, the method 300 also includes converting the logical network into a physical model of the production system. Some example implementations of block 312 include converting the logical network into a physical model of the production system comprising a rendering of the production system. For example, the relationship between a logical control node and its corresponding physical node, such as that described herein with respect to the logical control node 102 and physical node 104 may be used to convert each logical control node into a physical node, and use the data stored in the physical node, which defines a physical model or representation of the relevant physical production system elements for a portion of the production system, may be used in connection with example implementations of block 312. In some example implementations of block 312, converting the logical network into a physical model of the production system further comprises comparing the physical model of the production system to the hierarchical list of design requirements associated with the first portion of the production system and the hierarchical list of design requirements associated with the second portion of the production system. In such example implementations, the degree to which the physical model conforms to the relevant design requirements may be automatically or manually confirmed by iteratively testing the relevant requirements against the physical model, without needing to necessarily construct a full-scale production environment (and incur the costs in doing so) in advance of confirming that the production system design is aligned with the design requirements. In some example implementations of block 312, the physical model of the production system comprises a three-dimensional rendering of a spatial arrangement of design elements within the production system.

FIG. 3, in blocks 314, 316, and 318 present one approach to implementing block 312. As shown at block 314, example implementations of block 312 may include converting the first logical node into a first physical node. Some example implementations of block 314 include converting the first logical control node into a first physical node defining a spatial arrangement of design elements within the first portion of the production system. It will be appreciated that converting the first logical control node into a first physical node may involve leveraging the relationship between a logical control node and its corresponding physical node, such as the relationship discussed herein with respect to example logical control node 102 and example physical node 104.

Similarly, block 316 shows that some example implementations of block 312 may include converting the second logical control node into a second physical node. Some example implementations of block 316 include converting the second logical control node into a second physical node defining a spatial arrangement of design elements within the second portion of the production system, and may likewise leverage the relationship between a logical control node and its corresponding physical node, such as the relationship discussed herein with respect to example logical control node 102 and example physical node 104.

As shown in block 318, some example implementations of block 312 include arranging the first physical node and the second physical node in the physical model. Some example implementations of block 318 include arranging the first physical node and the second physical node in the physical model based on the relationship between the first design requirement stored in the first logical control node and the second design requirement stored in the second logical control node. In some situations, for example, there may be multiple acceptable arrangements of physical nodes that satisfy the requirements stored in the relevant logical control nodes.

As shown in FIG. 3, the method 300 may, in some example implementations, include several additional steps, depicted as blocks 320, 322, 324, and 326. Collectively, blocks 320-326 depict an approach for handling updates to one or more design elements associated with a logical control node, traversing the relevant logical network, and notifying related nodes of the design change. Any of the approaches described herein, including but not limited to those discussed in connection with FIG. 2 may be used in connection with optional steps 320, 322, 324, and 326. As show at block 320, some example implementations of the method 300 include receiving an update to the first design element stored in the first logical control node. It will be appreciated that in some production systems, updates to one or more design elements in a production system may be changed or adjusted in the course of developing a product to be developed, or to reflect other changes in the context in which a production system will be deployed. Since one of the advantages of some example implementations of method 300 is that the logical control node can act as a centralized location at which design information is stored, example implementations of block 320 contemplate storing design updates at a relevant logical control node.

As shown at block 322, some example implementations of method 300 include determining a relationship between the updated design requirement and the second design requirement stored in the second logical control node. In some example implementations of block 322, this is achieved by identifying a link between the first logical control node and the second logical control node. With reference to FIG. 2, links in a logical network disclosed herein are based on relationships between one or more logical control nodes and their respective requirements. As such, network can be traversed along the network connections to identify links between nodes. In example implementations of block 324, which includes providing an indication of the updated design requirement to the second logical control node, the indication of the updated design requirement can be passed from node to node via the links connecting the nodes. Consequently, by passing indication of design updates from node to node based on their respective connections, the nodes which may be impacted by a design change to one node can receive potentially relevant design information. Block 326 contemplates that, some situations, it may be advantageous to provide a user-readable notification of a design change. Some example implementations of block 326 include generating user-readable notification of the update to the first design requirement and adding the user-readable notification to the first logical control node and the second logical control node. In some example embodiments, the user-readable notification of the update may include a copy of the update itself, documentation associated with the update, or a summary describing the update. However, it will be appreciated that any approach to proving a user-readable notification of the update may be used in connection with example implementations of block 326.

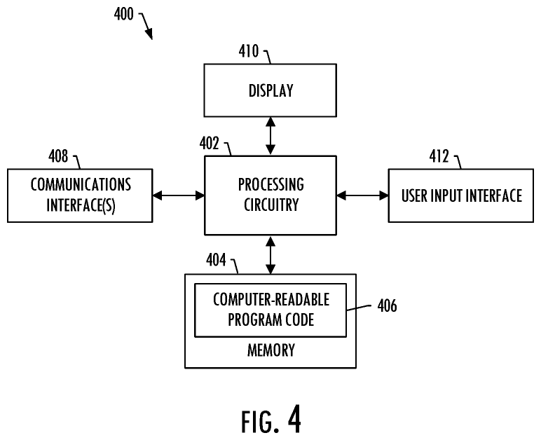

FIG. 4 illustrates an apparatus 400 according to some example implementations of the present disclosure. Generally, an apparatus of example implementations of the present disclosure may comprise, include or be embodied in one or more fixed or portable electronic devices. Examples of suitable electronic devices include computers such as desktop computers, server computers, portable computers (e.g., laptop computer, tablet computer), mobile phones (e.g., cell phone, smartphone), wearable computers (e.g., smartwatch), or the like. The apparatus may include one or more of each of a number of components such as, for example, processing circuitry 402 (e.g., processor unit) connected to a memory 404 (e.g., storage device). It will be appreciated that the computing device 106 may incorporate any of the features of the apparatus 400 disclosed herein.

The processing circuitry 402 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 404 (of the same or another apparatus).

The processing circuitry 402 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 404 is generally any piece of computer hardware that is capable of storing information such as, for example, data, computer programs (e.g., computer-readable program code 406) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 404, the processing circuitry 402 may also be connected to one or more interfaces for displaying, transmitting and/or receiving information. The interfaces may include a communications interface 40S (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 410 and/or one or more user input interfaces 412 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 400 may include a processing circuitry 402 and a computer-readable storage medium or memory 404 coupled to the processing circuitry, where the processing circuitry is configured to execute computer-readable program code 406 stored in the memory. It will also be understood that one or more functions, and combinations of functions, may be implemented by special purpose hardware-based computer systems and/or processing circuitry s which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for developing a production system comprising:
building a first logical control node associated with a first portion of a production system, the first logical control node configured as a structured data object containing a first hierarchical list of design requirements including at least one of a tooling requirement, equipment requirement, operational requirement, facility requirement, materials requirement, or assembly requirement associated with the first portion of the production system;
incorporating the first logical control node into a logical network comprising a plurality of logical control nodes associated with a plurality of other portions of the production system, incorporating the first logical control node including:
identifying a second logical control node from the plurality of logical control nodes, the second logical control node containing a second hierarchical list of design requirements of a second portion of the production system;
determining a relationship between a first design requirement stored in the first logical control node and a second design requirement stored in the second logical control node; and
defining a link between the first logical control node and the second logical control node based on the relationship; and
converting the logical network into a physical model of the production system comprising a rendering of the production system, converting the logical network including:
converting the first logical control node into a first physical node defining a spatial arrangement of design elements within the first portion of the production system;
converting the second logical control node into a second physical node defining a spatial arrangement of design elements within the second portion of the production system; and
arranging the first physical node and the second physical node in the physical model based on the relationship between the first design requirement stored in the first logical control node and the second design requirement stored in the second logical control node.

2. The method of claim 1, wherein defining the link between the first logical control node and the second logical control node comprises:
determining a precedential order between the first logical control node and the second logical control node; and
incorporating an indication of the precedential order into the link between the first logical control node and the second logical control node.

3. The method of claim 1 further comprising:
receiving an update to the first design requirement stored in the first logical control node;
determining a relationship between the updated first design requirement and the second design requirement stored in the second logical control node by identifying the link between the first logical control node and the second logical control node; and
providing an indication of the updated design requirement to the second logical control node.

4. The method of claim 3, further comprising generating a user-readable notification of the update to the first design requirement and adding the user-readable notification to the first logical control node and the second logical control node.

5. The method of claim 1, wherein the hierarchical list of design requirements comprises a design requirement received from a first data repository and a design requirement received from a second data repository, wherein the first data repository is not configured to communicate with the second data repository.

6. The method of claim 1, wherein converting the logical network into the physical model of the production system further comprises comparing the physical model of the production system to the hierarchical list of design requirements associated with the first portion of the production system and the hierarchical list of design requirements associated with the second portion of the production system.

7. The method of claim 1, wherein the physical model of the production system comprises a three-dimensional rendering of a spatial arrangement of design elements within the production system.

8. An apparatus for developing a production system, the apparatus comprising processing circuitry and a memory storing executable instructions that, in response to execution by the processing circuitry, cause the apparatus to at least:
build a first logical control node associated with a first portion of a production system, the first logical control node configured as a structured data object containing a first hierarchical list of design requirements including at least one of a tooling requirement, equipment requirement, operational requirement, facility requirement, materials requirement, or assembly requirement associated with the first portion of the production system;
incorporate the first logical control node into a logical network comprising a plurality of logical control nodes associated with a plurality of other portions of the production system, wherein the apparatus being caused to incorporate the first logical control node includes the apparatus being caused to:
identify a second logical control node from the plurality of logical control nodes, the second logical control node containing a second hierarchical list of design requirements of a second portion of the production system;
determine a relationship between a first design requirement stored in the first logical control node and a second design requirement stored in the second logical control node; and
define a link between the first logical control node and the second logical control node based on the relationship; and
convert the logical network into a physical model of the production system comprising a rendering of the production system, wherein the apparatus being caused to convert the logical network includes the apparatus being caused to:
convert the first logical control node into a first physical node defining a spatial arrangement of design elements within the first portion of the production system;
convert the second logical control node into a second physical node defining a spatial arrangement of design elements within the second portion of the production system; and
arrange the first physical node and the second physical node in the physical model based on the relationship between the first design requirement stored in the first logical control node and the second design requirement stored in the second logical control node.

9. The apparatus of claim 8, wherein the apparatus being caused to define the link between the first logical control node and the second logical control node comprises the apparatus being caused to:
determine a precedential order between the first logical control node and the second logical control node; and
incorporate an indication of the precedential order into the link between the first logical control node and the second logical control node.

10. The apparatus of claim 8, the apparatus being further caused to:
receive an update to the first design requirement stored in the first logical control node;
determine a relationship between the updated first design requirement and the second design requirement stored in the second logical control node by identifying the link between the first logical control node and the second logical control node; and
provide an indication of the updated design requirement to the second logical control node.

11. The apparatus of claim 10, the apparatus being further caused to generate a user-readable notification of the update to the first design requirement and adding the user-readable notification to the first logical control node and the second logical control node.

12. The apparatus of claim 8, wherein the hierarchical list of design requirements comprises a design requirement received from a first data repository and a design requirement received from a second data repository, wherein the first data repository is not configured to communicate with the second data repository.

13. The apparatus of claim 8, wherein the apparatus being caused to convert the logical network into the physical model of the production system further comprises the apparatus being caused to compare the physical model of the production system to the hierarchical list of design requirements associated with the first portion of the production system and the hierarchical list of design requirements associated with the second portion of the production system.

14. The apparatus of claim 8, wherein the physical model of the production system comprises a three-dimensional rendering of a spatial arrangement of design elements within the production system.

15. A computer-readable storage medium for developing a production system, the computer-readable storage medium being non-transitory and having computer-readable program code portions stored therein that in response to execution by a processor, cause an apparatus to at least:
build a first logical control node associated with a first portion of a production system, the first logical control node configured as a structured data object containing a first hierarchical list of design requirements including at least one of a tooling requirement, equipment requirement, operational requirement, facility requirement, materials requirement, or assembly requirement associated with the first portion of the production system;
incorporate the first logical control node into a logical network comprising a plurality of logical control nodes associated with a plurality of other portions of the production system, wherein the apparatus being caused to incorporate the first logical control node includes the apparatus being caused to:
identify a second logical control node from the plurality of logical control nodes, the second logical control node containing a second hierarchical list of design requirements of a second portion of the production system;
determine a relationship between a first design requirement stored in the first logical control node and a second design requirement stored in the second logical control node; and
define a link between the first logical control node and the second logical control node based on the relationship; and
convert the logical network into a physical model of the production system comprising a rendering of the production system, wherein the apparatus being caused to convert the logical network includes the apparatus being caused to:
convert the first logical control node into a first physical node defining a spatial arrangement of design elements within the first portion of the production system;
convert the second logical control node into a second physical node defining a spatial arrangement of design elements within the second portion of the production system; and
arrange the first physical node and the second physical node in the physical model based on the relationship between the first design requirement stored in the first logical control node and the second design requirement stored in the second logical control node.

16. The computer-readable storage medium of claim 15, wherein the apparatus being caused to define the link between the first logical control node and the second logical control node comprises the apparatus being caused to:
determine a precedential order between the first logical control node and the second logical control node; and
incorporate an indication of the precedential order into the link between the first logical control node and the second logical control node.

17. The computer-readable storage medium of claim 15, the apparatus being further caused to:
receive an update to the first design requirement stored in the first logical control node;
determine a relationship between the updated first design requirement and the second design requirement stored in the second logical control node by identifying the link between the first logical control node and the second logical control node; and
provide an indication of the updated design requirement to the second logical control node.

18. The computer-readable storage medium of claim 17, the apparatus being further caused to generate a user-readable notification of the update to the first design requirement and adding the user-readable notification to the first logical control node and the second logical control node.

19. The computer-readable storage medium of claim 15, wherein the hierarchical list of design requirements comprises a design requirement received from a first data repository and a design requirement received from a second data repository, wherein the first data repository is not configured to communicate with the second data repository.

20. The computer-readable storage medium of claim 15, wherein the apparatus being caused to convert the logical network into the physical model of the production system further comprises the apparatus being caused to compare the physical model of the production system to the hierarchical list of design requirements associated with the first portion of the production system and the hierarchical list of design requirements associated with the second portion of the production system.

21. The computer-readable storage medium of claim 15, wherein the physical model of the production system comprises a three-dimensional rendering of a spatial arrangement of design elements within the production system.
